(19) United States
(12) Patent Application Publication
(10) Pub. No.: US 2013/0255032 A1
(43) Pub. Date: Oct. 3, 2013

(54) Load-responsive flexible structure for supporting and mobilizing a platform

(71) Applicants: Roque Garcia, Las Cruces, NM (US); Joel Cosper, Dolores, CO (US)

(72) Inventors: Roque Garcia, Las Cruces, NM (US); Joel Cosper, Dolores, CO (US)

(21) Appl. No.: 13/437,389

(22) Filed: Apr. 2, 2012

(51) Int. Cl. B60B 33/00

(52) U.S. Cl. 16/45

(57) ABSTRACT

A load-responsive U-shaped flexible leg with wheels for converting a platform such as an inverted bucket into a simple rolling step stool.

### CROSS-REFERENCE TO RELATED APPLICATIONS

None.

### STATEMENTS REGARDING FEDERALLY SPONSORED RESEARCH AND DEVELOPMENT

Not applicable.

### BACKGROUND

The embodiments of the present invention satisfy the needs of having a load-responsive flexible structure for supporting and mobilizing a platform on which a person may stand, such as a rolling step stool, or climb, such as a rolling library ladder.

Information relevant to attempts to address these problems can be found in U.S. Pat. Nos. 7,364,172; 6,889,998; 5,800,570; 4,708,362; which are not admitted to be prior art with respect to the present invention by its mention in this Background Section. However, it is desirable to have a better device than is disclosed in the references.

At present, most existing rolling step stools are comparatively complex devices with spring-mounted casters, such that for a variety of reasons they cannot be used as models for simpler rolling step stools. For one, the casters alone cannot be easily attached to common household devices in order to improvise a rolling step stool.

### SUMMARY

The embodiments of the present invention are directed to a method and a system that satisfy the needs set out in the Background section.

The embodiments of the present invention utilize a push clamp mechanism to create a rolling step stool or ladder. Resilient flexible legs, made perhaps from strips of sheet metal or strips of a sheet of a plastic having a resilience and flexibility comparable to sheet metal, are attached to a stepping platform. These legs yield to a downward force on the platform such that a portion of each leg is pinned to the ground by the downward force on the platform, and any wheels attached to those legs are superseded and thereby rendered inoperable. The downward force in this case is that of a human standing on the stepping platform. Unlike pivotably connected frames which employ rigid legs that can be spread or that spread in response to a load (e.g., U.S. Pat. Nos. 6,889,998; 4,708,362), the embodiments of the present invention utilize U-shaped flexible load responsive legs that can non-pivotably yield (i.e., flatten open) under a downward force, and then flex back to their original u-shaped position when the force is lifted. In one embodiment, a proximal end of each leg is removably attachable to a bucket, and a wheel is removably attachable to a distal end of each leg. It is this wheel that is rendered inoperable when a downward force from a person standing on the bucket pins a portion of each leg to the ground. One embodiment of the present invention comprises the above-mentioned flexible leg, which may be sold separately or in sets. It is important that the legs are both resilient and flexible, so that they straighten in response to a downward force and allow the bucket or platform to pin them. It is important that the legs are wide and thin, for the same reason. The farther away the wheel is from the bucket, the better the balance when rolling because the wheels are less prone to shifting. When using an inverted bucket, it helps to secure the bucket handle to the bucket with a rubber band. Another embodiment of the present invention comprises a complete rolling step stool made with a plurality of these flexible legs. In this embodiment the same features are required for the legs as in the first embodiment, though here the entire device, except the wheels, can be molded as one part.

The embodiments of the present invention perform a similar function as a standard rolling step stool or a rolling library ladder, but without the spring-mounted caster. The embodiments of the present invention thus replace the spring-mounted caster and associated locking leg with a simple one-piece flexible leg.

Unlike dollies that facilitate the rolling transport of a bucket, which facilitate pushing a filled bucket such as U.S. Pat. No. 7,364,172 and the patents referenced therein, the embodiments of the present invention invert the bucket and use it as a step stool.

The embodiments of the present invention comprise a load-responsive flexible structure for supporting and mobilizing a platform comprising:

a leg in a shape of an inverted U, wherein the leg comprises a strip of a sheet of resilient flexible material, wherein the leg non-pivotably yields under a downward force, wherein the leg flexes back to an original inverted U shape when the downward force is lifted, wherein the leg comprises a leg proximal end and a leg distal end, wherein the leg proximal end is removably attachable to a platform for standing, wherein a downward force of a person standing on the platform both causes an attached leg to non-pivotably yield and causes the platform to pin a portion of the attached leg to a supporting surface on which the platform rests; and
a wheel removably attachable to the leg distal end, wherein the wheel is rendered ineffective when the platform pins a portion of the attached leg to a supporting surface on which the platform rests.

A plurality of these legs, usually three or more, when attached to a platform, have the effects of supporting the platform, rendering the platform mobile, and emulating a rolling step stool or similar device such as a library ladder.

Optionally, the wheel is a swivel caster with a monolithically extending vertical shaft, wherein the vertical shaft is removably positionable in a hole in the leg distal end.

Optionally, the platform for standing is an inverted bucket.

Optionally, the platform for standing is a ladder. Here each leg cradles and lifts a ladder from the underside of each of the two vertical struts. A ladder comprises two vertical struts and a plurality of horizontal rungs.

Optionally, the leg proximal end is folded back on itself to comprise a clip adapted for attaching to a rim of the platform.

Optionally, the leg is coated with a non-slip coating. That includes the inside of the clip, as well as the base where the leg contacts the supporting surface.

Optionally, the resilient flexible material is selected from the group consisting of stainless steel, cold roll steel, hot roll steel, tool steel, aluminum, copper, brass, bronze, nickel, titanium, magnesium and zinc, and beryllium copper.

Optionally, the resilient flexible material is selected from the group consisting of polyethylene, polypropylene, copolymers of polyethylene and polypropylene, polytetrafluoroethylene, acrylonitrile butadiene styrene, polyvinylchloride, ethylene vinyl acetate, and polystyrene.

Optionally, the embodiments of the present invention comprise a rolling platform for standing, comprising:

a non-rolling platform for standing, that is, a platform on which a person can stand;
a plurality of load-responsive flexible legs wherein each leg comprises a strip of a sheet of resilient flexible material, wherein each leg comprises an inverted U-shaped structure, wherein each leg non-pivotably yields under a downward force, wherein each leg flexes back to an original inverted U shape when the downward force is lifted, wherein each leg comprises a leg proximal end and a leg distal end, wherein each leg proximal end is removably attached to the platform for standing, wherein a downward force of a person standing on the platform both causes each leg to non-pivotably yield and causes the platform to pin a portion of each leg to a supporting surface on which the platform rests; and
a wheel removably attached to each leg distal end, wherein each wheel is rendered ineffective when the platform pins a portion of each leg to a supporting surface on which the platform rests.

Optionally, each wheel is a swivel caster with a monolithically extending vertical shaft, wherein each vertical shaft is removably positionable in a hole in each leg distal end.

Optionally, each leg proximal end is folded back on itself to comprise a clip adapted for attaching to a rim of the platform.

Optionally, the non-rolling platform for standing is a ladder. Here each leg cradles and lifts a ladder from the underside of each of the two vertical struts. A ladder comprises two vertical struts and rungs.

Optionally, the non-rolling platform for standing is a stool.

Optionally, the leg is coated with a non-slip coating.

Optionally, the resilient flexible material is selected from the group consisting of stainless steel, cold roll steel, hot roll steel, tool steel, aluminum, copper, brass, bronze, nickel, titanium, magnesium and zinc, and beryllium copper.

Optionally, the resilient flexible material is selected from the group consisting of polyethylene, polypropylene, copolymers of polyethylene and polypropylene, polytetrafluoroethylene, acrylonitrile butadiene styrene, polyvinylchloride, ethylene vinyl acetate, and polystyrene.

### SOME ADVANTAGES OF THE EMBODIMENTS OF THE INVENTION

In the embodiments of the present invention, an inverted bucket such as a five-gallon bucket can be transformed into an improvised rolling step stool. Such buckets are common at contractor job sites. An otherwise stationary ladder can be similarly transformed.

These and other advantages will become apparent as the embodiments of the invention are used.

### DRAWINGS

These and other features, aspects and advantages of the embodiments of the device and/or methods will become better understood with reference to the following description, appended claim and accompanying drawings where:

FIG. 1a shows a perspective view of a load-responsive flexible leg;

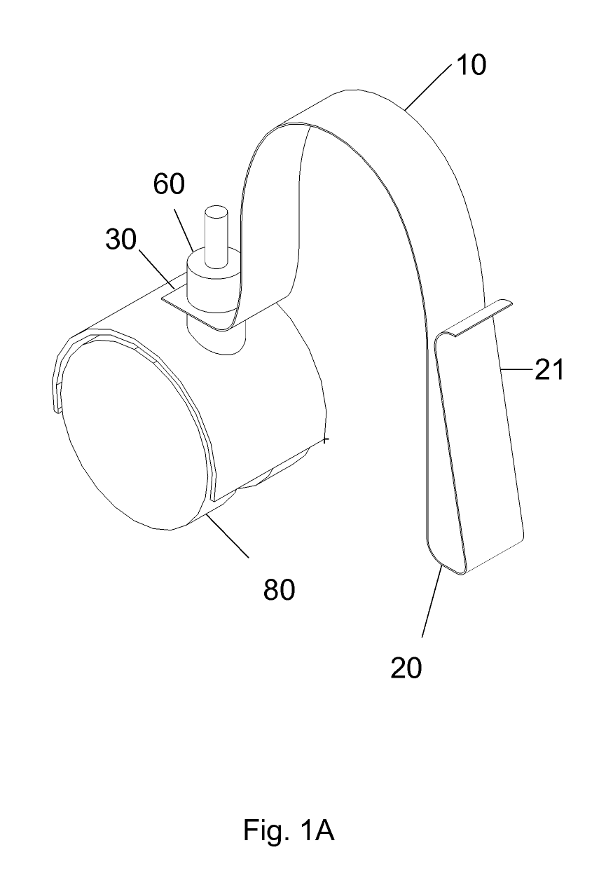

FIG. 1b shows a perspective view of a plurality of load-responsive flexible legs attached to an inverted bucket;

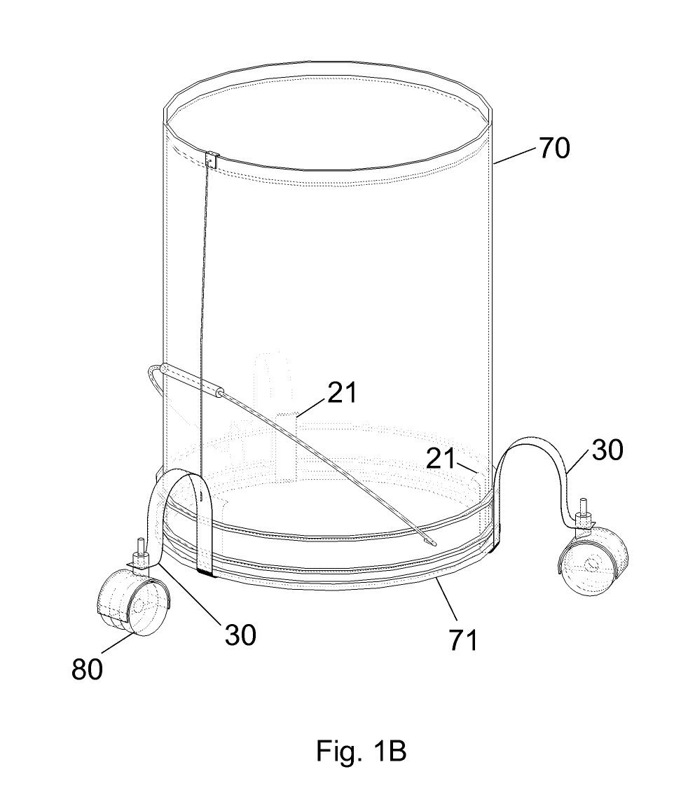

FIG. 2 shows a perspective view of a plurality of load-responsive flexible legs attached to an inverted bucket, when a downward force has clamped the legs to the ground.

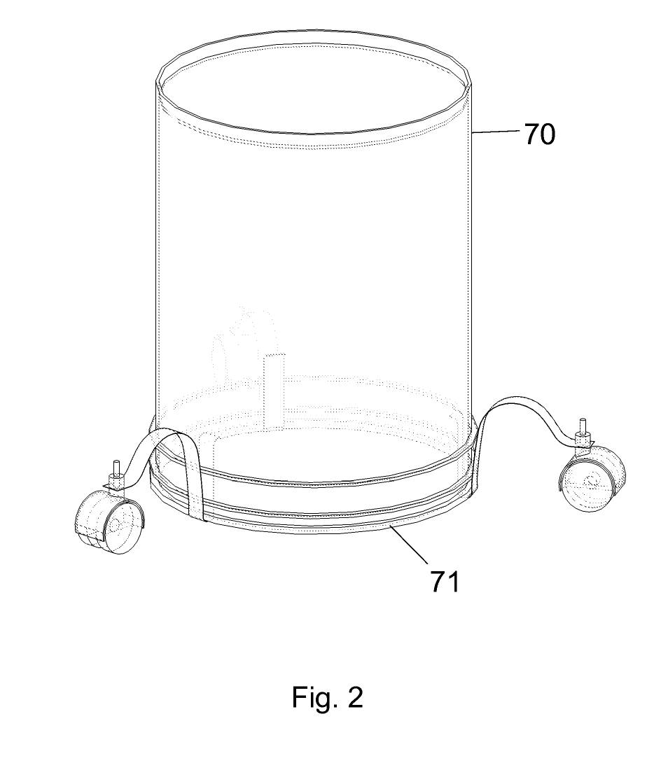

### REFERENCE NUMBERS

10 Leg
20 Leg proximal end
21 Clip
30 Leg distal end
60 Vertical shaft
70 Platform
71 Rim
80 Wheel

### DESCRIPTION

### Definitions

Non-slip coating includes but is not limited to a co-extruded tacky thermoplastic elastomer, PVC-based, rubber, and duct tape.

Non-pivotably yielding legs means flexible load responsive U-shaped legs that can yield or flatten open under a downward force, and then flex back to their original U-shaped position when the force is lifted; in contrast to pivotably connected frames which employ rigid legs that can be spread or that spread in response to a load as in U.S. Pat. Nos. 6,889,998 and 4,708,362. Yielding in this case means longitudinally flexing, as discussed in U.S. Pat. No. 5,800,570.

### DESCRIPTION OF THE PREFERRED EMBODIMENT AND BEST MODE

As shown in the figures, the preferred embodiment and best mode of the present invention comprise a load-responsive flexible structure comprising:

a leg 10 in a shape of an inverted U, wherein the leg 10 comprises a strip of a sheet of resilient flexible material 10, wherein the leg 10 non-pivotably yields under a downward force, wherein the leg 10 flexes back to an original inverted U shape when the downward force is lifted, wherein the leg 10 comprises a leg proximal end 20 and a leg distal end 30, wherein the leg proximal end 20 is removably attachable to a platform 70 for standing, wherein a downward force of a person standing on the platform 70 both causes an attached leg 10 to non-pivotably yield and causes the platform 70 to pin a portion of the attached leg 10 to a supporting surface on which the platform 70 sits; and
a wheel 80 removably attachable to the leg distal end 30, wherein the wheel 80 is rendered ineffective when the platform 70 pins a portion of the attached leg 10 to a supporting surface on which the platform 70 rests.

In the preferred embodiment of the removably attachable leg, the platform 70 for standing is an inverted bucket, and a plurality of legs 10 are attached thereto. The leg proximal end 20 is folded back on itself to comprise a money clip-type clip 21 adapted for attaching to a rim 71 of the platform 70. The leg 10 is coated with a non-slip coating. The leg 10 is made of sheet aluminum.

The wheel 80 can be a readily-available swivel caster with a monolithically extending vertical shaft 60, wherein the vertical shaft 60 is removably positionable in a hole in the leg distal end 30.

Some advantages of the embodiments of the apparatus were previously enumerated in the Summary section. Every advantageous feature does not need to be incorporated into every embodiment of the apparatus and/or methods.

Although these versions of the invention have been described in considerable detail, other versions are possible. For example, embodiments can comprise combinations of the features described herein, such as combinations of the dependent claims. Therefore, the spirit and scope of the appended claims should not be limited to the description of the versions contained therein.

We claim:

1. A load-responsive flexible structure for supporting and mobilizing a platform comprising:
a. a leg in a shape of an inverted U, wherein the leg comprises a strip of a sheet of resilient flexible material, wherein the leg non-pivotably yields under a downward force, wherein the leg flexes back to an original inverted U shape when the downward force is lifted, wherein the leg comprises a leg proximal end and a leg distal end, wherein the leg proximal end is removably attachable to a platform for standing, wherein a downward force of a person standing on the platform both causes an attached leg to non-pivotably yield and causes the platform to pin a portion of the attached leg to a supporting surface on which the platform rests; and
b. a wheel removably attachable to the leg distal end, wherein the wheel is rendered ineffective when the platform pins a portion of the attached leg to a supporting surface on which the platform rests.

2. The structure of claim 1, wherein the wheel is a swivel caster with a monolithically extending vertical shaft, wherein the vertical shaft is removably positionable in a hole in the leg distal end.

3. The structure of claim 1, wherein the platform for standing is an inverted bucket.

4. The structure of claim 1, wherein the platform for standing is a ladder, wherein the ladder comprises vertical struts and horizontal rungs, wherein the legs are removably attachable to the vertical struts.

5. The structure of claim 1, wherein the leg proximal end is folded back on itself to comprise a clip adapted for attaching to a rim of the platform.

6. The structure of claim 1, wherein the leg is coated with a non-slip coating.

7. The structure of claim 1, wherein the resilient flexible material is selected from the group consisting of stainless steel, cold roll steel, hot roll steel, tool steel, aluminum, copper, brass, bronze, nickel, titanium, magnesium and zinc, and beryllium copper.

8. The structure of claim 1, wherein the resilient flexible material is selected from the group consisting of polyethylene, polypropylene, copolymers of polyethylene and polypropylene, polytetrafluoroethylene, acrylonitrile butadiene styrene, polyvinylchloride, ethylene vinyl acetate, and polystyrene.
